(19) United States
(12) Patent Application Publication
(10) Pub. No.: US 2007/0112505 A1
(43) Pub. Date: May 17, 2007

(54) Equidistant area locator website

(76) Inventors: Dean Brandon Rossi, Scotch Plains, NJ (US); Karen Katherine Rossi, Scotch Plains, NJ (US)

Correspondence Address: DEAN ROSSI, 4 DONSEN LANE, SCOTCH PLAINS, NJ, 07076, US

(21) Appl. No.: 11/280,642

(22) Filed: Nov. 17, 2005

(51) Int. Cl. G01C 21/00

(52) U.S. Cl. 701/200; 701/201

(57) ABSTRACT

A website that is easily usable and functional. It allows for two or more zip codes or towns to be entered and finds for the user towns, which lie equidistant between the entered areas of departure, and not too far out of the way. It then allows the user to view establishments listed for each of the resultant towns.

### FIELD OF THE INVENTION

The present invention relates to finding geographical locations, and more particularly, to finding a location that is equidistant from two or more areas of departure, while also lying between them.

### BACKGROUND OF THE INVENTION

In situations where two or more people want to meet to talk, celebrate, catch up, date or for countless other reasons, one of the first questions needed to be answered prior to meeting is “where should we meet?” When people are not coming from either the same town, or directly adjacent towns, the simple answer of my town or your town is inevitably inconvenient for one party or another. Ideally the parties like to be able to meet somewhere in between the respective residences that is fair and reasonably equidistant for all.

There is no simple, quick way to find an equidistant waypoint or meeting place. The problem is exacerbated when more than tow parties are involved. The current options are that all go either to one person's town, to a town somewhere in between, selected because it is familiar to one or more parties or, most bothersome though most accurate, a destination found by breaking out a map, if available.

There is no direct prior solution to the problem of finding an equidistant meeting place between two or more non-boarding towns. Currently, whether using digital means or a physical device, the only solution is to use a map or direction giving software, and to add in a healthy dose of time and effort to estimate the median place to meet.

Establishment locator software routines used by many physical establishment related web sites to help users find the establishments, while finding locations near to one zip code, do not find locations that are common to two or more zip codes and equidistant to all.

Although as stated above, there is no other solution designed to solve this direct problem, using a map or direction giving software comes the closest. The drawbacks to using a map, beyond not getting directly to the heart of the issue, are manifold. One issue is that multiple maps may be needed to view all of the involved points of origin. Another is the granularity needed to pinpoint small towns. The largest drawback is the effort involved and inherent lack of accuracy in eyeballing distance.

It is an object of the invention to find an area identified by a zip code.

It is an object of the invention to find an area that is both equidistant between two or more locations and which lies as close as possible to directly between the locations.

It is a further object of the invention to offer a selection of areas of destination between given locations and to rank such locations based on a combination of both equidistance and distance or simply on proximity to a central area.

It is an object of the invention to provide establishments within resultant locations at which people may meet.

It is a further object of the invention to allow for customized results based on areas of destination qualified by other means, such as only areas containing a specified restaurant or hotel chain.

### SUMMARY OF THE INVENTION

In accordance with the present invention, there is provided a website that allows for two or more zip codes or towns to be entered and finds towns which lie approximately equidistant between the entered areas of departure, not too far out of the way. It then allows the user to view establishments listed for each of the resultant towns. A plurality of potential meeting locations can be ranked for the user.

### BRIEF DESCRIPTION OF THE DRAWINGS

A complete understanding of the present invention may be obtained by reference to the accompanying drawings, when considered in conjunction with the subsequent, detailed description, in which:

FIGS. 1 and 2, taken together represent a flowchart of the destination ranking process for two areas of destination or origin;

FIG. 3 is a flowchart of the destination ranking process for more than two areas of destination;

FIG. 4 is a representation of the areas of destination that are excluded from and included in ranking consideration for two areas of departure process; and

FIG. 5 is a representation similar to that shown in FIG. 4, for more than two areas of departure.

For purposes of clarity and brevity, like elements and components will bear the same designations and numbering throughout the FIGURES.

The invention is a website that allows a user to enter two or more areas of departure, generally cities or towns, and finds for them centrally located areas of destination, again cities or towns and ranks them for the user. It also finds places to meet in the centrally located towns, such as eateries, hotels and more. The website is accessible via a browser, web service and mobile device. It can also be customized to search for areas of destination based on characteristics of the destinations themselves, such as only destinations that have a particular restaurant.

It is important to make clear before describing the details of the invention that two primary participating factors can be altered to fit other situations as they may arise. Areas of departure (origin) and destination are currently represented by zip codes, but can be represented by area codes, GPS locations, exits on highways, buildings or any other means of identifying geographic areas or regions. Distances between the various areas used in the calculations herein are based on longitude and latitude and the straight distance between two points. Distances can also be calculated, however based on real world driving directions or various other means of gaging distances between two geographic areas or regions.

The current invention consists of two versions: one that accepts only two areas of departure and one that accepts more than two areas of departure. There are similarities and differences in the ways the processes arrive at a resultant group of areas of destination for their respective areas of departure. Both processes are preferably designed to work with points of departure represented by zip codes. Areas that lie approximately equidistant between the provided areas of departure represent potential areas of destination. The process for only two areas of departure is more efficient in considering overall traveling distance when ranking areas of destination. An area that lies the same distance from the first area of departure and the second area of departure, but directs both travelers an extra 20% out of their way, may be less convenient than an area of destination that is slightly closer to one area of departure than the other, but requires each traveler to travel only an extra 5% out of their way.

The calculations and rankings for the two areas of departure version work from the understanding that the perfect area of destination lies absolutely halfway between the areas of departure, like a dot in the middle of a straight line. The calculations and rankings for the multiple areas of departure version work more like an optimization engine designed to establish a weighted center between all of the involved areas of destination. Each process works in concert with the notion that the perfect middle area is highly unlikely to ever exist in geographic reality for any given set of areas of departure and that it is the job of the process to assess the best options, expecting none to be perfect. Given the subjective nature of the term “best” as used above, user interaction is be involved to allow users to select from a ranked result set to determine their “best” area.

The adjustment of the thresholds and variances in other enhancements of the invention allows the processes to flexibly adjust it's output based on user preferences. One user may want a tighter variance over pure equidistance, while giving more leeway on pure distance overage. Another user may have the exact opposite preferences, and both can be accommodated.

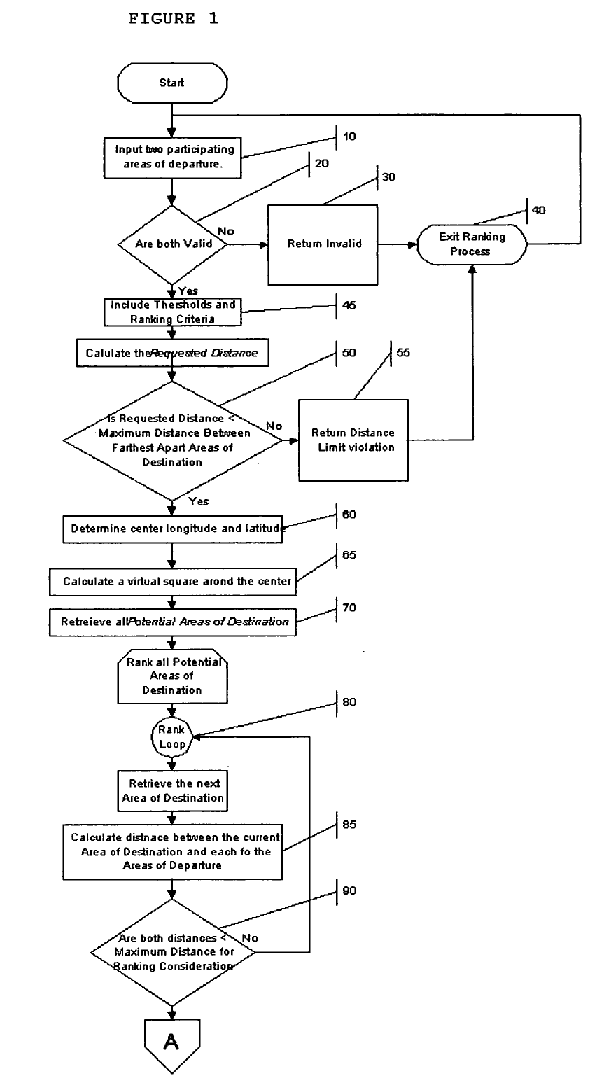

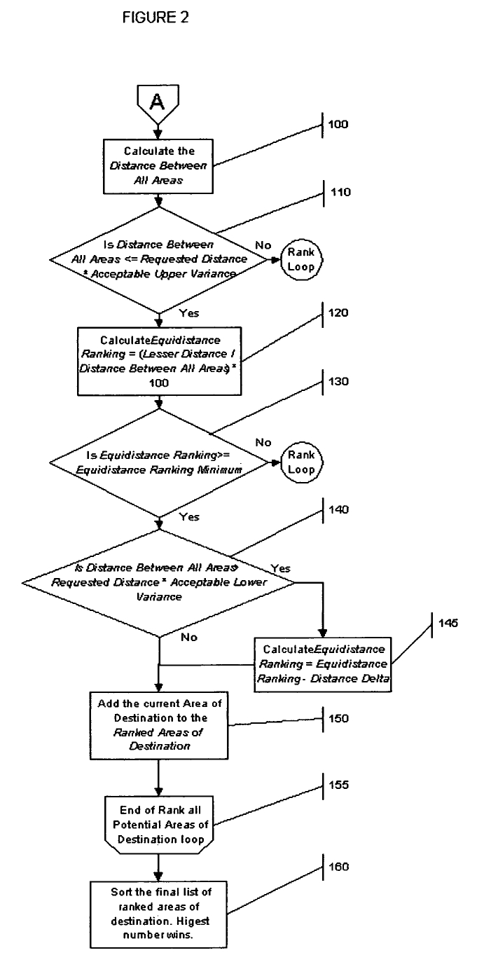

Referring now to FIGS. 1 and 2, the first step in the process is to enter two locations (areas of departure), step 10. The system determines whether each area is valid, step 20. An invalid area is one with a non-existent zip code or town and state combination for example. If either area is not valid the original information is presented back to the user marking the errant fields for correction, step 30, the process exits, step 40 and control is returned to the user for adjustment or reentry of locations, step 10.

The system then sets ranking criteria variables received from any combination of the user, internal settings or external systems, step 45, which include but are not limited to threshold values, establishment types found in destination locations, and the like. Calculate the overall requested distance and check to see if it is within the maximum allowed distance threshold, step 50. If the requested distance exceeds the maximum allowed distance threshold, the original information is presented back to the user stating the reason for the failure, step 55, the process exits, step 40 and control is returned to the user for adjustment or reentry of locations, step 10.

The center longitude and latitude between the two participating areas of departure is determined, step 60, by a simple calculation applied to the longitude and latitude of both areas. Having established the geographic center of the two areas, step 60, a virtual square of longitude and latitude designations is calculated, using the geographic center, step 60, as its center, whose width is a predetermined percentage (e.g., 50%) of the distance between the two areas of departure, step 65. A working set of potential areas of destination is created that is limited to those that reside within the square, step 65, step 70. The square reaches halfway to each area of departure assuring the process will have enough equidistant areas of destination while limiting the amount of extraneous areas of destination that are too far to one side or another to survive the ranking process.

Next, all of the potential areas of destination, step 70, are ranked in a processing loop, step 80. The distance between each area of destination and each area of departure is calculated, step 85. If the distance to either area of departure is greater than the maximum distance for ranking consideration, step 90, the area of destination is discarded and the next area of destination is retrieved.

The next step in the process is to calculate for each of the areas of destination, how much their inclusion in a trip from one area of departure to another would increase the overall length of the trip. This step asks how far out of the way would the travelers have to go to meet in this area. The distance between the first area of departure and the area of destination, is added to the distance from the second area of departure to the area of destination. From that total, the distance between the two areas of departure is subtracted, step 100. The result is the increase in distance. This number is then converted to its percentage of the distance between the first area of departure and the second area of departure for use in the ranking calculation.

The use of the percentage of the increase over the original direct distance, instead of the actual increase in distance, reflects sensitivity to a convenience threshold that is relative to the overall distance between the original areas of departure. As an example, if two areas of departure are twenty miles apart, traveling to an area of destination that adds two miles to the original distance would be reasonable. Adding two miles to an original distance of ten miles might not be reasonable. In one case only 10% is added to the overall distance, while in the second case, 20% is added. The line of delineation between an acceptable and an unacceptable increase is subjective, but the threshold should change relative to overall distance.

Although the numbers can be massaged as needed, the ranking calculation currently assesses no penalty for a variance of 10% or less, assesses increasing penalty points from 10.01% to 20%, and removes areas from consideration the variance of which is greater than 20%, which is the acceptable upper variance.

If the distance between all areas for a given area of destination is greater than the distance between the two areas of departure plus 20%, or the acceptable upper variance, the area of destination is removed from the ranking process, step 110.

Next calculate the equidistance ranking, step 120, by dividing the shorter of the two distances between the area of destination and the two areas of departure, by the distance between all areas. Multiply the result by 100 to attain the equidistance rank for the current area of destination. If the equidistance rank is less than the equidistance ranking minimum allowed, which is initially set at 40 (but can be altered to accommodate different preferences), the area of destination is removed from the ranking process, step 130.

The equidistance ranking minimum, in this case 40, represents the lower half of a 40/60 split in how far each of the travelers will have to travel to reach the area of destination. One would travel 60% of the overall distance, and the other one would travel only 40%.

At this final stage in the ranking process, it is determined if a penalty is to be assessed because the area of destination is too far out of their way or not, step 140. If the distance between all areas is greater than the distance between the original two areas of departure multiplied by an acceptable lower variance, then a distance penalty number is subtracted from the current equidistance ranking number, step 145. The distance penalty number is relative to how much greater the distance between all areas is then the distance directly between the two areas of departure. This calculation assures that consideration is given not only to equidistance, but also to general convenience of the areas of destination.

The area of destination is added to the collection of all ranked areas of destination, step 150. When all potential areas of destination have been ranked and added to the collection, step 155, the areas of destination are sorted, step 160, with the highest ranking scores winning the process and being presented to the user first, and the lowest ranking scores losing and being presented to the user last or possibly not at all, depending upon the limitations of the technology platforms involved and user preferences regarding how many they want to see.

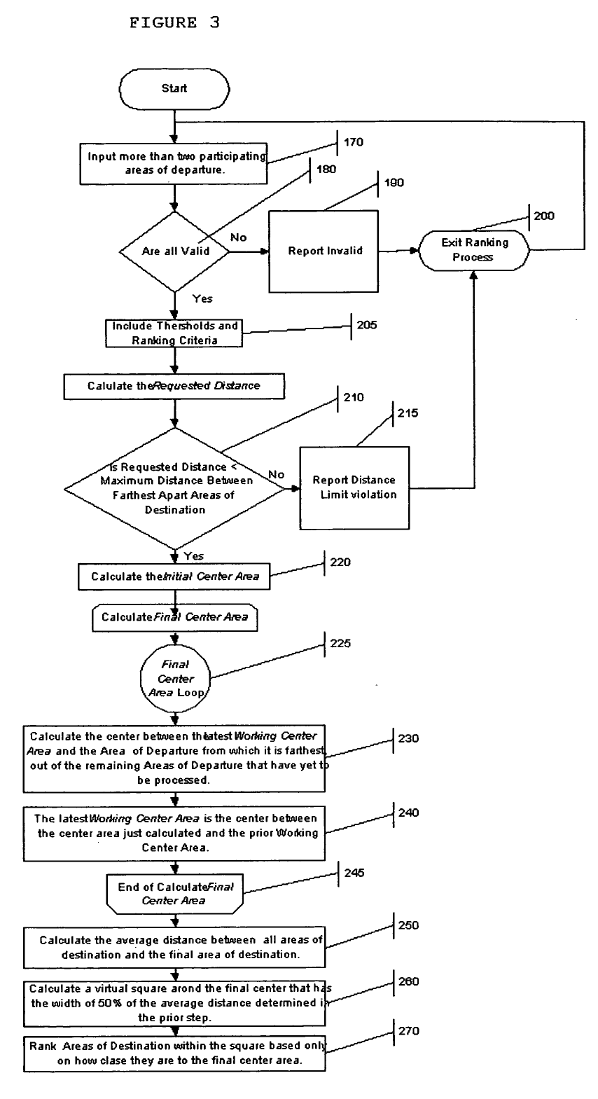

Referring now to FIG. 3, the logic for processing more than two areas of departure differs slightly from the logic used for processing only two areas of departure, and is as follows: first enter more than two locations (areas of departure), step 170. The system determines whether each area is valid, step 180. An invalid area is one with a non-existent zip code or town and state combination for example. If either area is not valid the original information is presented back to the user marking the errant fields for correction, step 190, the process exits, step 200 and control is returned to the user for adjustment or reentry of locations, step 170.

The system then sets ranking criteria variables received from any combination of the user, internal settings or external systems, step 205, which include but are not limited to threshold values, establishment types found in destination locations, and the like. Calculate the overall requested distance by determining the two farthest apart areas of departure and check to see if it's within the maximum allowed distance threshold, step 210. If the requested distance exceeds the maximum allowed distance threshold, the original information is presented back to the user stating the reason for the failure, step 215, the process exits, step 200 and control is returned to the user for adjustment or reentry of locations, step 170.

Find the two areas of departure that are the farthest apart from one another. The center longitude and latitude between the two farthest areas of departure is determined, step 220, by a simple calculation applied to the longitude and latitude of both areas.

The next step is a repeated process that ends in the establishment of a final center between all of the participating areas of destination. The first step in the process to discover the final center is to find from the areas of departure not yet processed, the one that's farthest from the latest calculated center which is called the “working” center and to determine the center between the area of departure and the working center, step 230. Now find the center between the just identified center and the working center, this new center becomes the latest working center, step 240.

When the final working center has been established, step 245, which is called the “final” center, the average distance between the final center and all of the areas of departure is calculated, step 250. We limit the working set of potential areas of destination to those that reside within a square whose center is the final center and whose width is 50% of the average distance that we just established, step 260. Finally, we rank the areas found in the square by how close the areas are to the final center, step 270.

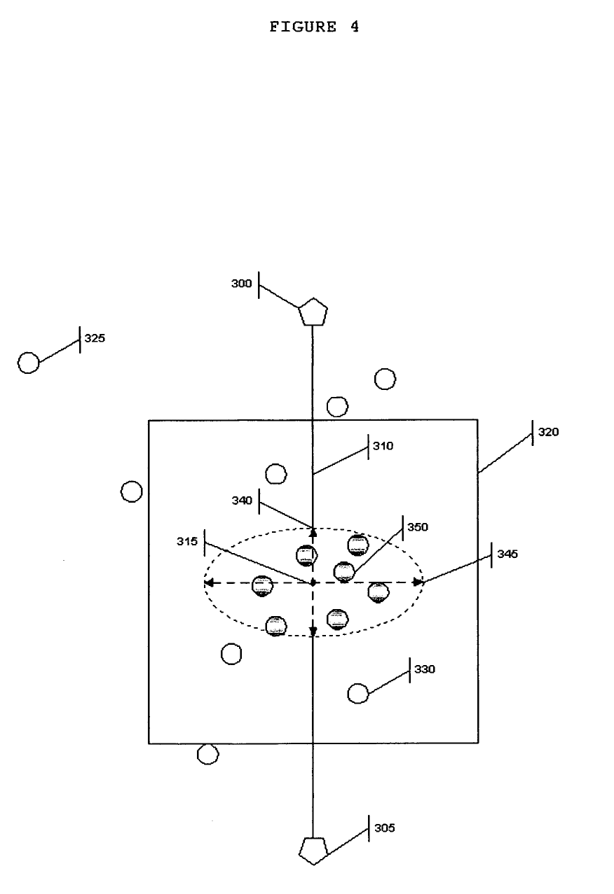

Referring now to FIG. 4, a topographical view of the results of a search concerning two areas of departure, first the two areas of departure are entered and validated, 300 and 305. The distance between the two areas of destination 310 is measured and assessed against the maximum allowed distance threshold. A center longitude and latitude 315 between the two areas of departure is determined.

A virtual square of longitude and latitude designations is calculated, using the geographic center 320 as its center. Areas outside of the virtual square, 325, are not eligible ranking. Areas inside the square but outside of the ellipse 330 are removed from ranking for either being too far to one area of departure or the other, or for being too far out of the way.

Ranking happens along the two arrows that move out from the center, with the rank value diminishing the farther from the center that the area of destination resides. The vertical arrows 340 represent equidistance and the horizontal arrows 345 represent convenience. The areas of destination within the ellipse 350 are presented back to the user reflecting their assigned rank.

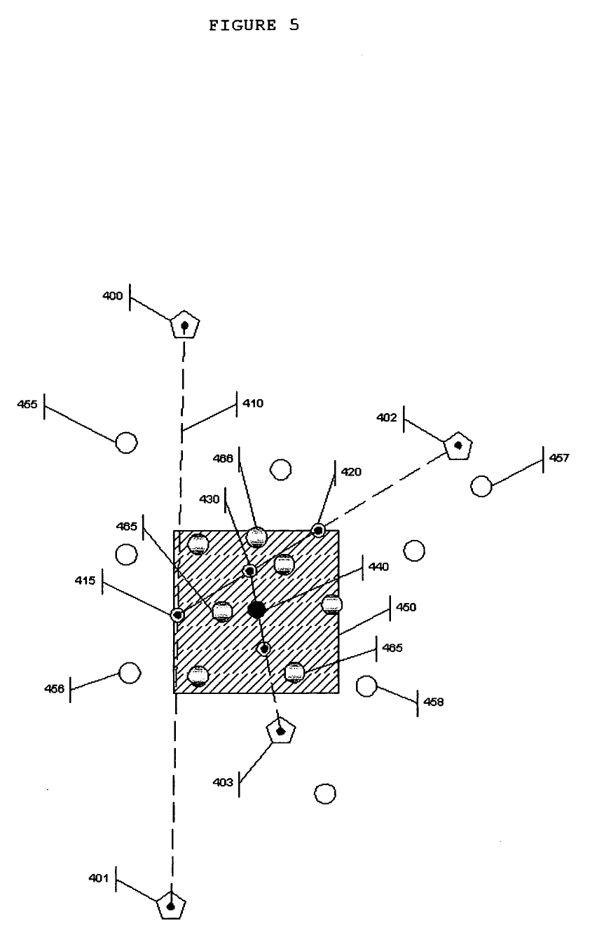

Referring now to FIG. 5, a topographical view of the results of a search concerning more than two areas of departure, first the areas of departure 400, 401, 402 and 403 are entered and validated. The distance between the two areas of destination 410 is measured and assessed against the maximum allowed distance threshold. A center longitude and latitude 415 between the two farthest areas of departure is determined, which is called the latest working center.

Next a repeating process establishes new working centers until a final center is established. Each working center is established by first calculating the center 420 between the current working center and the farthest area of departure. Next the center is found between the center just established and the current working center, this new center becomes the new current working center 430. This process ends when the last working center has been found, which becomes the final center 440.

A virtual square 450 of longitude and latitude designations is calculated, using the final center's position as its center. The square's width is 50% of the average distance between the final center and all areas of departure. The Areas outside of the virtual square 455, 456, 457, 458 are not eligible ranking. Finally, the areas found to be in the square 465, 466, 467 are ranked by how close each is to the final center.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of the invention.

Having thus described the invention, what is desired to be protected by Letters Patent is presented in the subsequently appended claims.

What is claimed is:

1. A method of determining a plurality of locations intermediate two areas of departure and presenting a ranking thereof to a user, the steps comprising:
a) providing data representative of the location of a first area of departure and of a second area of departure, respectively;
b) calculating coordinates representative of the midpoint of said two areas of departure based on said data representative of the locations thereof;
c) defining a destination area, said destination area comprising one of the group: triangle, square, rectangle, circle, polygon, and an area bounded by natural features, said destination area having a center point at said midpoint and a boundary displaced therefrom, said destination area boundary being no more than 50% of the distance between said midpoint and either of said areas of departure; and
d) identifying at least one destination in said destination area pursuant to predetermined selection criteria.

2. The method of determining a plurality of locations intermediate two areas of departure and presenting a ranking thereof to a user, in accordance with claim 1, the steps further comprising:
e) determining the additional distance from: i) said first point of departure to said at least one destination, to ii) the distance from said midpoint to said first point of departure and converting said additional distance into a percentage of said distance from said midpoint to said first point of departure.

3. The method of determining a plurality of locations intermediate two areas of departure and presenting a ranking thereof to a user, in accordance with claim 1, wherein said data representative of the location of a first area of departure and of a second area of departure comprises at least one of the group: latitude, longitude, zip code, area code, linear distance from a predetermined landmark, and geographical survey map information.

4. The method of determining a plurality of locations intermediate two areas of departure and presenting a ranking thereof to a user, in accordance with claim 1, wherein said predetermined selection criteria comprises at least one of the group: landmark, restaurant, park, recreational area, amusement park, sports stadium, arena, theater, highway, and casino.

5. The method of determining a plurality of locations intermediate two areas of departure and presenting a ranking thereof to a user, in accordance with claim 1, the steps further comprising:
e) if more than one destination is identified in accordance with step (d), ranking said destinations in order of convenience and interest.

6. The method of determining a plurality of locations intermediate two areas of departure and presenting a ranking thereof to a user, in accordance with claim 5, wherein said ranking is dependent upon at least one of the group: said data representative of the location of a first area of departure and of a second area of departure, and said predetermined selection criteria.

7. The method of determining a plurality of locations intermediate two areas of departure and presenting a ranking thereof to a user, in accordance with claim 2, wherein said ranking is dependent upon at least one of the group: said percentage of distance, said data representative of the location of a first area of departure and of a second area of departure, and said predetermined selection criteria.

8. The method of determining a plurality of locations intermediate two areas of departure and presenting a ranking thereof to a user, in accordance with claim 3, the steps further comprising:
e) determining the additional distance from: i) said first point of departure to said at least one destination, to ii) the distance from said midpoint to said first point of departure and converting said additional distance into a percentage of said distance from said midpoint to said first point of departure; and
f) if more than one destination is identified in accordance with step (d), ranking said destinations in order of convenience and interest, said ranking being dependent upon at least one of the group: said percentage of said distance, said data representative of the location of a first area of departure and of a second area of departure, and said predetermined selection criteria.

9. The method of determining a plurality of locations intermediate two areas of departure and presenting a ranking thereof to a user, in accordance with claim 4, the steps further comprising:
e) determining the additional distance from: i) said first point of departure to said at least one destination, to ii) the distance from said midpoint to said first point of departure and converting said additional distance into a percentage of said distance from said midpoint to said first point of departure; and
f) if more than one destination is identified in accordance with step (d), ranking said destinations in order of convenience and interest, said ranking being dependent upon at least one of the group: said percentage of said distance, said data representative of the location of a first area of departure and of a second area of departure, and said predetermined selection criteria.

10. A method of determining a plurality of locations intermediate a plurality of areas of departure and presenting a ranking thereof to at least one user, the steps comprising:
a) providing data representative of the location of each of a plurality of areas of departure, respectively;
b) calculating data representative of a first midpoint of a first of said plurality of areas of departure and a second of said plurality of areas of departure based on said data representative of the locations thereof;
c) calculating data representative of a composite midpoint of a third of said plurality of areas of departure and said first midpoint, based on said data representative of the locations thereof;
d) repeating step (c) for each of the remaining plurality of areas of departure until each of said plurality of areas of departure is exhausted, updating said data representative of said composite midpoint prior to each repeated calculation;
e) defining a destination area, said destination area comprising one of the group: triangle, square, rectangle, circle, polygon, and area bounded by natural features, said destination area having a center point at said updated composite midpoint and a boundary displaced therefrom, said destination area boundary being no more than 50% of the distance between said updated composite midpoint and any of said plurality of areas of departure; and
f) identifying at least one destination in said destination area pursuant to predetermined selection criteria.

11. The method of determining a plurality of locations intermediate a plurality of areas of departure and presenting a ranking thereof to at least one user, in accordance with claim 10, the steps further comprising:
g) determining the additional distance from: i) said first point of departure to said at least one destination, to ii) the distance from said midpoint to said first point of departure and converting said additional distance into a percentage of said distance from said midpoint to said first point of departure.

12. The method of determining a plurality of locations intermediate two areas of departure and presenting a ranking thereof to a user, in accordance with claim 10, wherein said data representative of the location of a first area of departure and of a second area of departure comprises at least one of the group: latitude, longitude, zip code, area code, linear distance from a predetermined landmark, and geographical survey map information.

13. The method of determining a plurality of locations intermediate two areas of departure and presenting a ranking thereof to a user, in accordance with claim 10, wherein said predetermined selection criteria comprises at least one of the group: landmark, restaurant, park, recreational area, amusement park, sports stadium, arena, theater, highway, and casino.

14. The method of determining a plurality of locations intermediate a plurality of areas of departure and presenting a ranking thereof to at least one user, in accordance with claim 10, the steps further comprising:
g) if more than one destination is identified in accordance with step (f), ranking said destinations in order of convenience and interest.

15. The method of determining a plurality of locations intermediate two areas of departure and presenting a ranking thereof to a user, in accordance with claim 14, wherein said ranking is dependent upon at least one of the group: said data representative of the location of a first area of departure and of a second area of departure, and said predetermined selection criteria.

16. The method of determining a plurality of locations intermediate two areas of departure and presenting a ranking thereof to a user, in accordance with claim 15, wherein said ranking is dependent upon at least one of the group: said percentage of distance, said data representative of the location of a first area of departure and of a second area of departure, and said predetermined selection criteria.

17. The method of determining a plurality of locations intermediate a plurality of areas of departure and presenting a ranking thereof to at least one user, in accordance with claim 12, the steps further comprising:
g) determining the additional distance from: i) said first point of departure to said at least one destination, to ii) the distance from said midpoint to said first point of departure and converting said additional distance into a percentage of said distance from said midpoint to said first point of departure; and
h) if more than one destination is identified in accordance with step (f), ranking said destinations in order of convenience and interest, said ranking being dependent upon at least one of the group: said percentage of said distance, said data representative of the location of a first area of departure and of a second area of departure, and said predetermined selection criteria.

18. The method of determining a plurality of locations intermediate a plurality of areas of departure and presenting a ranking thereof to at least one user, in accordance with claim 13, the steps further comprising:
g) determining the additional distance from: i) said first point of departure to said at least one destination, to ii) the distance from said midpoint to said first point of departure and converting said additional distance into a percentage of said distance from said midpoint to said first point of departure; and
h) if more than one destination is identified in accordance with step (f), ranking said destinations in order of convenience and interest, said ranking being dependent upon at least one of the group: said percentage of said distance, said data representative of the location of a first area of departure and of a second area of departure, and said predetermined selection criteria.

19. A method of determining a plurality of locations intermediate a plurality of areas of departure and presenting a ranking thereof to at least one user, the steps comprising:
a) providing data, accessible over a world wide communications network, representative of the location of each of a plurality of areas of departure, respectively;
b) calculating data representative of a first midpoint of a first of said plurality of areas of departure and a second of said plurality of areas of departure based on said data representative of the locations thereof;
c) calculating data representative of a composite midpoint of a third of said plurality of areas of departure and said first midpoint, based on said data representative of the locations thereof;
d) repeating step (c) for each of the remaining plurality of areas of departure until each of said plurality of areas of departure is exhausted, updating said data representative of said composite midpoint prior to each repeated calculation;
e) defining a destination area, said destination area comprising one of the group: triangle, square, rectangle, circle, polygon, and area bounded by natural features, said destination area having a center point at said updated composite midpoint and a boundary; and
f) identifying at least one destination in said destination area pursuant to predetermined selection criteria, said at least one destination identification being accessible over said world wide communications network.

20. The method of determining a plurality of locations intermediate a plurality of areas of departure and presenting a ranking thereof to at least one user, in accordance with claim 19, the steps further comprising:
g) if more than one destination is identified in accordance with step (f), ranking said destinations in order of convenience and interest.
